(19) United States
(12) Patent Application Publication
(10) Pub. No.: US 2025/0321472 A1
(43) Pub. Date: Oct. 16, 2025

(54) Hybrid metasurface-refractive projector module

(71) Applicant: APPLE INC., Cupertino, CA (US)

(72) Inventors: Maoz Ovadia, Kiryat Ono (IL); Moshe Kriman, Tel Aviv (IL); Aharon R. Barnea, Ramat Gan (IL); Yaron Gross, Netanya (IL); Roei Remez, Tel Aviv (IL); Dana Gal-Fuss, Tel Aviv (IL); Refael Della Pergola, Jerusalem (IL)

(21) Appl. No.: 19/054,942

(22) Filed: Feb. 17, 2025

Related U.S. Application Data
(60) Provisional application No. 63/632,534, filed on Apr. 11, 2024.

(51) Int. Cl. G03B 21/20; G02B 1/00; G03B 21/14

(52) U.S. Cl. CPC G03B 21/208; G02B 1/002; G03B 21/147; G03B 21/2013

(57) ABSTRACT

An optoelectronic apparatus includes an array of emitters configured to emit beams of optical radiation. Refractive optics focus the emitted beams with a first optical power. An optical metasurface splits the focused beams to form a pattern of spots and applies a vergence to the spots with a second optical power so as to project the pattern of spots toward a target.

### CROSS-REFERENCE TO RELATED APPLICATION

This application claims the benefit of U.S. Provisional Patent Application 63/632, 534, filed Apr. 11, 2024, which is incorporated herein by reference.

### FIELD OF THE INVENTION

The present invention relates generally to optoelectronic devices, and particularly to sources of optical radiation.

### BACKGROUND

Various sorts of portable computing devices (referred to collectively as “portable devices” in the description), such as smartphones, augmented reality (AR) devices, virtual reality (VR) devices, smart watches, and smart glasses, comprise compact sources of optical radiation. These sources, commonly called pattern projectors, project patterned radiation (spot illumination) so as to illuminate a target with a pattern of spots for three-dimensional (3D) mapping of the region. Additionally, these sources may emit flood radiation, illuminating the target with uniform illumination (flood illumination) over a wide field of view for the purpose of color image capture.

The terms “optical rays,” “optical radiation,” and “light,” as used in the present description and in the claims, refer generally to electromagnetic radiation in any or all of the visible, infrared, and ultraviolet spectral ranges.

Optical metasurfaces are thin layers that comprise a two-dimensional pattern of repeating structures, having dimensions (pitch and thickness) less than the target wavelength of the radiation with which the metasurface is designed to interact. Optical elements comprising optical metasurfaces are referred to herein as “metasurface optical elements” (MOEs).

U.S. Patent Application Publication 2022/0179125, whose disclosure is incorporated herein by reference, describes a pattern projector based on metamaterials. An optical element includes a single transparent substrate. A first metasurface disposed on the single transparent substrate is configured to focus an input beam of optical radiation that is incident on the optical element. A second metasurface disposed on the single transparent substrate is configured to split the input beam into an array of multiple output beams.

### SUMMARY

Embodiments of the present invention that are described hereinbelow provide improved designs and methods of fabrication of sources of optical radiation.

There is therefore provided, in accordance with an embodiment of the invention, an optoelectronic apparatus, including an array of emitters configured to emit beams of optical radiation and refractive optics configured to focus the emitted beams with a first optical power. An optical metasurface is configured to split the focused beams to form a pattern of spots and to apply a vergence to the spots with a second optical power so as to project the pattern of spots toward a target.

In some embodiments, the optical metasurface is further configured to apply a linear spatial phase shift to the pattern of spots so as to deflect a projection angle of the pattern. In a disclosed embodiment, the first optical power of the refractive optics causes a zero order of the optical metasurface to form a defocused spot on the target, wherein the defocused spot does not coincide with any of the spots in the pattern due to the deflected projection angle of the pattern.

In a disclosed embodiment, an absolute value of the second optical power is less than the first optical power. Additionally or alternatively, the second optical power is positive. Further alternatively, the second optical power is negative.

In some embodiments, the optical metasurface has an additional polynomial phase selected to correct an optical aberration of the refractive optics and/or to correct a field curvature of the refractive optics.

In a disclosed embodiment, the first optical power is selected so that a zero order of each of the emitted beams forms a blurred spot on the target.

In one embodiment, the optical metasurface is disposed on a surface of the refractive optics.

In some embodiments, the pattern of spots includes multiple diffraction orders of the emitted beams, and the optical metasurface is configured to control relative intensities of the diffraction orders. In a disclosed embodiment, the optical metasurface is configured to attenuate one or more of the diffraction orders that are outside a predefined field of view. Additionally or alternatively, the apparatus includes an optical detector, which is configured to receive a high diffraction order that is not directed toward the target and to monitor a power of the beams by detecting the high diffraction order.

In another embodiment, the apparatus includes an optical detector array, which is configured to receive a high diffraction order that is reflected from a part of the target that is in close proximity to the apparatus and to output a signal indicative of a distance of the part of the target from the apparatus.

In a disclosed embodiment, the array of emitters that emits the beams for projecting the pattern of spots is a first emitter array, and the apparatus includes a second emitter array, which is configured to emit further optical radiation and is disposed alongside the first emitter array and displaced axially relatively to the first emitter array, wherein the refractive optics and optical metasurface are configured to project the further optical radiation onto the target as flood illumination.

There is also provided, in accordance with an embodiment of the invention, a method for optical projection, which includes focusing beams of optical radiation emitted by an array of emitters using refractive optics with a first optical power. An optical metasurface is applied to split the focused beams to form a pattern of spots and to apply a vergence to the spots with a second optical power so as to project the pattern of spots toward a target.

The present invention will be more fully understood from the following detailed description of the embodiments thereof, taken together with the drawings in which:

### BRIEF DESCRIPTION OF THE DRAWINGS

FIG. 1 is a schematic side view of an optoelectronic apparatus, in accordance with an embodiment of the invention;

FIG. 2A is a schematic frontal view of a metasurface used in the apparatus of FIG. 1, in accordance with an embodiment of the invention;

FIG. 2B is a schematic detail view of the metasurface of FIG. 2A;

FIG. 2C is a schematic frontal view of a spot pattern projected onto a target by the apparatus of FIG. 1, in accordance with an embodiment of the invention;

FIG. 2D is an enlarged view of a central part of the pattern of FIG. 2C;

FIG. 3 is a schematic frontal view of a projected pattern of spots, in accordance with another embodiment of the invention;

FIG. 4 is a schematic side view of an optoelectronic apparatus for pattern projection, in accordance with another embodiment of the invention;

FIG. 5 is a schematic side view of an optoelectronic apparatus for pattern projection, in accordance with a further embodiment of the invention; and

FIG. 6 is a schematic side view of an optoelectronic apparatus for pattern and flood projection, in accordance with an embodiment of the invention.

### DETAILED DESCRIPTION OF EMBODIMENTS

### Overview

The use of a single MOE in a pattern projector for both collimation and beamsplitting is an attractive option in terms of reduced cost and total track length (TTL). A pattern projector based on this sort of single MOE, however, requires a large optical aperture and is prone to artifacts. As a result, practical implementation can be challenging.

Therefore, in embodiments of the present invention that are described herein, a pattern projector comprises refractive optics for collimating the beams of optical radiation emitted by an array of emitters, together with an MOE for beam steering and splitting. Even in such embodiments, however, periodic MOE designs can suffer from process-and design-related phase errors, which reduce the uniformity of the projected spot pattern and produce stray light. Moreover, the zero (undiffracted) orders of the emitted beams can generate unwanted ghost spots, which can interfere with detection of the projected pattern, for example for purposes of depth mapping.

Some embodiments of the present invention, as described hereinbelow, address these issues by adding optical power to the design of the MOE (either positive or negative). Additionally or alternatively, the MOE may be designed to apply a spatially linear phase gradient across the area of the MOE. In some embodiments, a single optical metasurface both splits and applies optical power to the beams and may also apply the spatially linear phase gradient to tilt the beams.

The optical power of the MOE adds to (or subtracts from) the optical power of the refractive optics so that the combined optical power produces collimated beams projected toward the target. The zero order of each of the emitted beams, however, is affected by only the partial collimation provided by the refractive optics and thus forms a blurred ghost spot with reduced intensity on the target. In some embodiments, the absolute value of the optical power of the MOE is small compared to the optical power of the refractive optics, i.e., the MOE applies relatively weak vergence to the beams. (“Vergence” in this context can be either convergence, when the optical power of the MOE is positive, or divergence, when the optical power of the MOE is negative.) Designing the MOE with weak vergence loosens the alignment tolerance and thus simplifies the process of manufacturing the pattern projector.

The addition of a spatially linear phase gradient across the MOE adds an optical phase offset to all the beams traversing the MOE, wherein the phase offset is a linear function of a spatial coordinate across the MOE. Specifically, the phase varies linearly across each beam of optical radiation projected by the MOE, causing each beam to be deflected by a certain angular deflection. The addition of the linear phase gradient breaks the strict periodicity of the two-dimensional pattern of repeating structures of the MOE. This modification reduces process—and design—related phase errors, improving the uniformity of the projected spot pattern, and reducing the amount of stray light.

In an example embodiment, the MOE may have positive focal power, with a focal length of 25-40 mm for an overall system effective focal length of 2.7 mm. The added spatially linear phase gradient may be selected, for example, to yield an angular deflection of 1.2°. In alternative embodiments, other added optical powers and angular deflections may be selected.

Additionally or alternatively, the MOE may be designed to correct for field curvature and optical aberrations of the refractive optics. In further embodiments, beams projected by the MOE at extreme angles may be used for proximity sensing or monitoring the power of emitters in array, for example as described in U.S. Patent Application Document 2023/0073962, whose disclosure is incorporated herein by reference. In other embodiments, the MOE may be designed to lower the intensity of these extreme beams, or even completely extinguish them.

### System Description

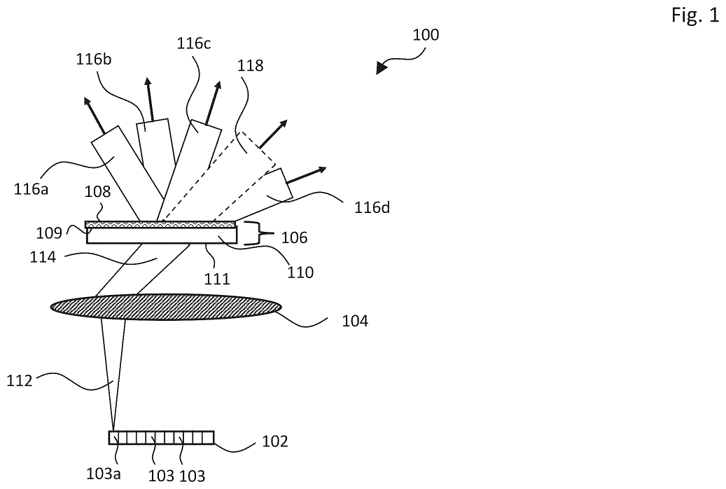

FIG. 1 is a schematic side view of an optoelectronic apparatus 100 for pattern projection, in accordance with an embodiment of the invention.

Apparatus 100 comprises an array 102 of emitters 103, refractive optics 104, and an MOE 106. Emitters 103 in this example comprise vertical-cavity surface emitting lasers (VCSELs), although emitters of other kinds may alternatively be used.

Refractive optics 104 comprise a single- or multi-element refractive lens, fabricated of plastic, glass, or other suitable material that is transparent at the wavelengths of the beams emitted by array 102.

MOE 106 comprises an optical metasurface 108 formed on a transparent substrate 110. Although metasurface 108 is shown on a top side 109 of substrate 110 in FIG. 1, the metasurface may alternatively be formed on a bottom side 111. (Alternatively, metasurface 108 may be disposed directly on a surface of refractive optics 104.) Metasurface 108 steers and splits the optical beams focused by optics 104. Additionally, metasurface 108 has both a weak optical power and a spatially linear phase gradient added across its surface, as previously described.

For projecting a pattern of spots toward a target (not shown), each of emitters 103 in array 102 emits a beam of optical radiation. For the sake of clarity, only one beam 112, emitted by an emitter 103a, is shown in FIG. 1. Beam 112 impinges on optics 104, which focus the beam with a predefined optical power to form a beam 114, which is directed toward MOE 106. (In FIG. 1, beam 114 is slightly divergent, but alternatively, beam 114 may converge, depending on optics 104.) Metasurface 108 splits and collimates beam 114 to form beams 116a, 116b, 116c, and 116d, and steers and projects these beams toward the target. The spatially linear phase gradient of metasurface 108 deflects the projection angle of the beam fan comprising beams 116a-d to the left relative to the axis of beam 114 in the view shown in FIG. 1. A portion of beam 114 is unaffected by metasurface 108, thus forming a zero-order beam 118.

The combined optical powers of optics 104 and MOE 106 are chosen such that each beam 116a, 116b, . . . , is collimated, and the beams thus form a discrete, high-contrast spot pattern on the target, as will be detailed in the figures that follow. Zero order beam 118, however, is affected only by the optical power of optics 104 but not by the optical power of MOE 106 and thus is not fully collimated but rather forms a blurred ghost spot with reduced intensity on the target. This defocused ghost spot does not coincide with any of the spots in the pattern formed by beams 116a-d due to the deflected projection angle of the pattern.

Each emitter 103 emits a beam similar to beam 112, which after focusing by optics 104 and splitting and collimating by metasurface 108 forms similarly multiple collimated beams (and a zero-order beam) projected toward the target.

Although the pictured embodiment shows four beams 116a, 116b, 116c, and 116d, alternative embodiments may comprise either a higher or a lower number of such beams.

### Metasurface Designs

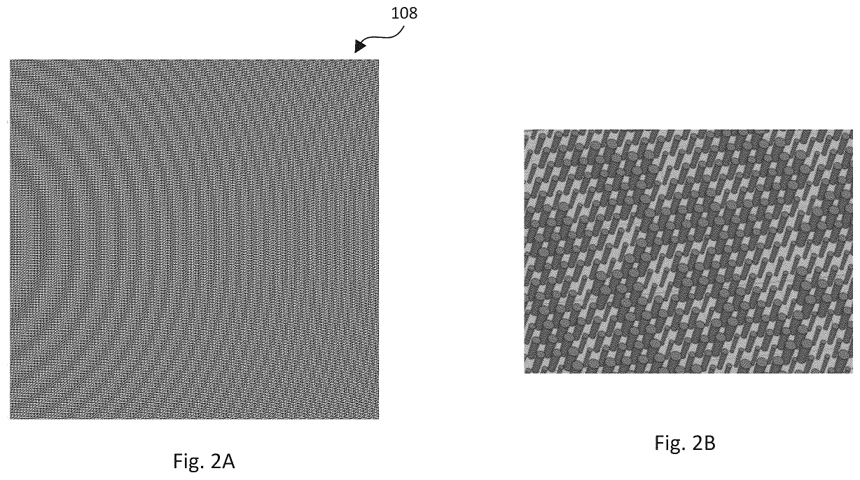

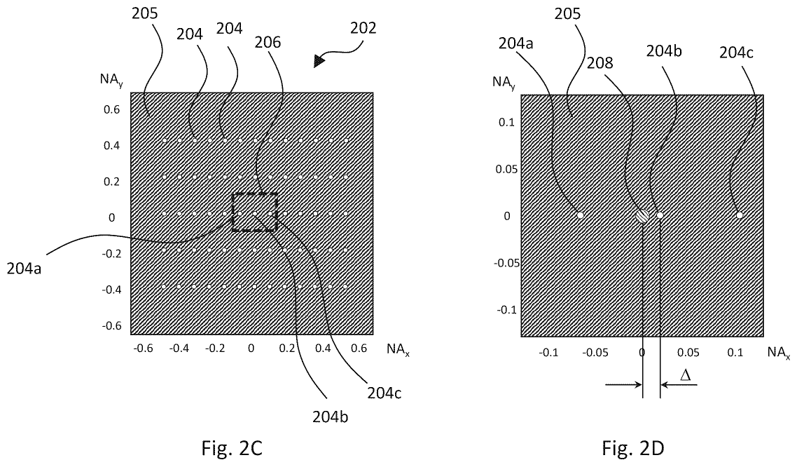

FIGS. 2A and 2B show details of metasurface 108, in accordance with an embodiment of the invention. FIG. 2A is a schematic frontal view of metasurface 108, while FIG. 2B shows an enlargement of a part of the metasurface. Metasurface 108 in this embodiment comprises an array of microscopic pillars, which are deposited on a transparent substrate and have dimensions less than the wavelength of emitters 103, i.e., typically less than about 500 nm. As illustrated in FIG. 2B, the sizes of the pillars vary over the area of the array to create a pattern of varying optical phase. Metasurfaces of this sort are commercially available from a number of foundries. The pattern of pillars in FIG. 2A both splits each incident beam 114 into multiple outgoing beams and applies both a vergence (positive or negative) and a linear spatial phase shift to the outgoing beams. As may be seen in FIG. 2A, the vergence is expressed in a pattern of rings, while the spatial symmetry of metasurface 108 is broken by the linear spatial phase shift. As noted earlier, the linear phase shift and optical power added to the pattern of metasurface 108 are beneficial in reducing the effects of irregularities and artifacts.

FIGS. 2C and 2D show spot patterns projected onto a target by apparatus 100, in accordance with an embodiment of the invention. The lateral scales on both figures are given in two-dimensional NA-space (numerical aperture space), wherein NA refers to the sines of the directional angles of beams 116a, 116b, . . . , emitted by apparatus 100.

FIG. 2C shows a rectilinear pattern 202 of spots 204 on a target 205, produced by the beams projected from apparatus 100. An area 206 comprises three of spots 204: spots 204a, 204b, and 204c, as well as a zero-order spot 208 (visible in FIG. 2D).

FIG. 2D shows an enlarged view of area 206 of FIG. 2C. Zero order spot 208 is located at the center of the field at NA-coordinates NAₓ=0 and NA_{y}=0. Zero order spot 208 is blurred due to the division of the optical power between optics 104 and MOE 106, as explained hereinabove. Due to the blurring, zero order spot 208 is larger than any of spots 204, and has a lower intensity than these spots, and thus interferes with pattern 202 less than an unblurred zero order spot would. Pattern 202, as exemplified by spots 204a, 204b, and 204c, is shifted in a horizontal direction (NAₓ-direction) by a shift A due to the spatially linear phase gradient added across the surface of MOE 106. In FIG. 2D, the shift A is much smaller than the horizontal spacing of spots 204, for example, spots 204b and 204c. In alternative embodiments, shift A may have other ratios to the spacing between spots 204 of pattern 202, and it may be directed in other directions than the horizontal direction, such as the vertical direction or a direction between the horizontal and vertical directions.

### Alternative Embodiments

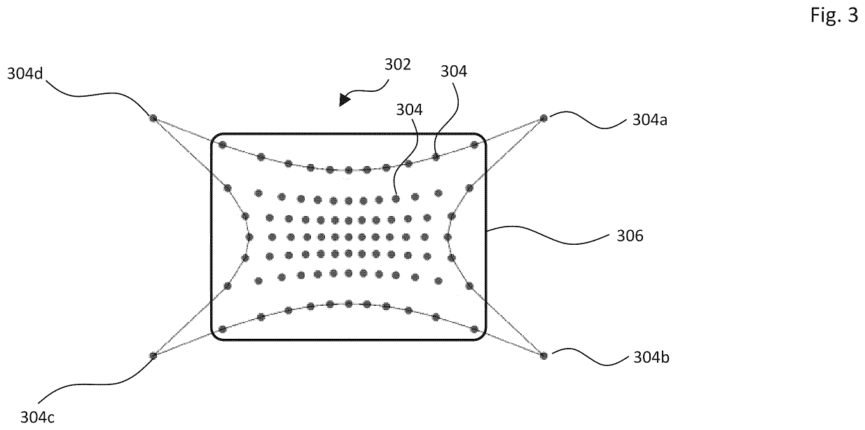

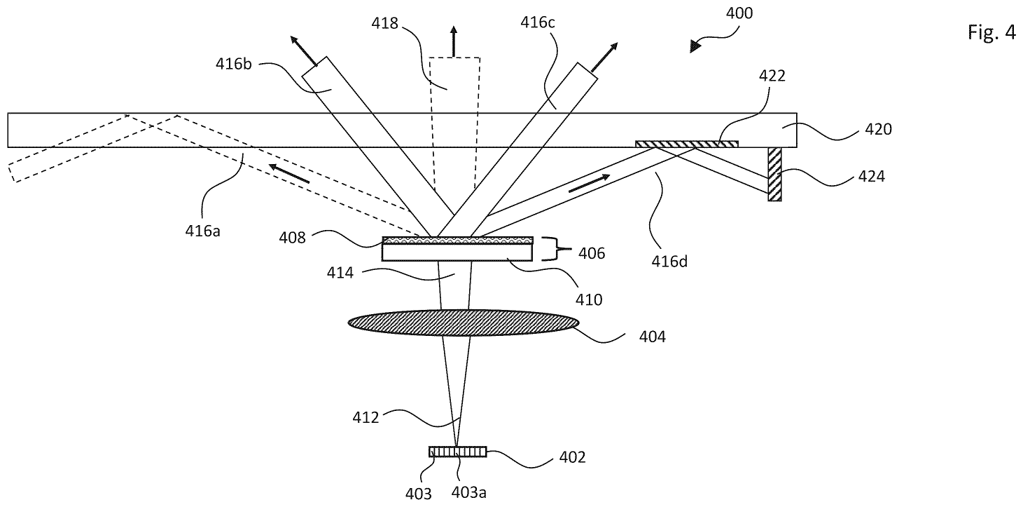

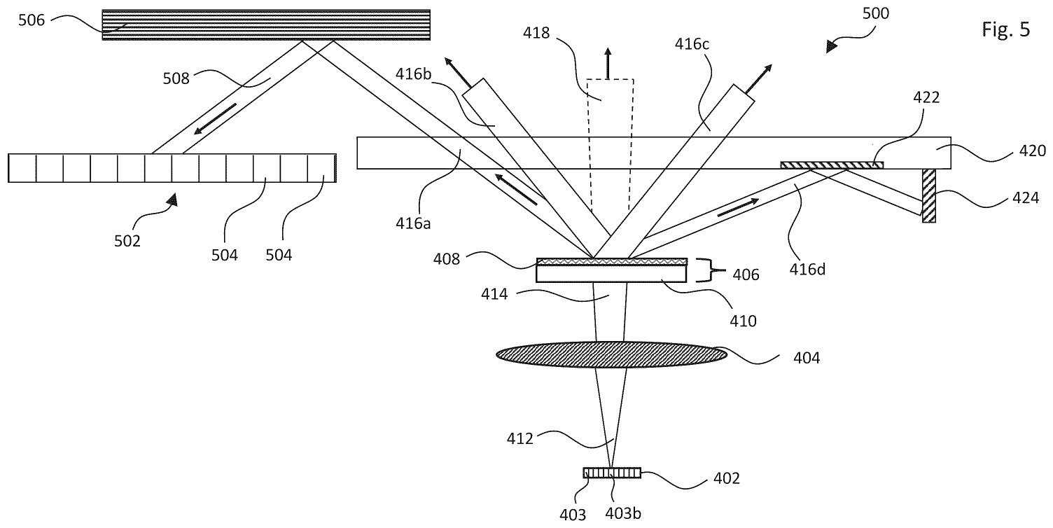

FIG. 3 is a schematic frontal view of a pattern 302 of spots 304 projected onto a field 306, in accordance with an embodiment of the invention. Pattern 302 is projected by an apparatus similar to apparatus 100 (FIG. 1), but having optics that impose so-called pin-cushion distortion on the projected pattern. Due to the distortion, spots 304a, 304b, 304c, and 304d, located in the four corners of pattern 302, are located outside field 306. The high-NA beams forming these spots may be used for proximity sensing or monitoring the power of emitters in array 102, as described in the above referenced U.S. Patent Application Document 2023/0073962. In alternative embodiments, metasurface 108 of MOE 106 may be tailored to reduce or even extinguish the intensity in the beams that form spots 304a, 304b, 304c, and 304d. In further embodiments, such as those shown in FIGS. 4 and 5, hereinbelow, some of these spots may be used for proximity sensing or power monitoring, while the intensity of others may be reduced or extinguished.

FIG. 4 is a schematic side view of an optoelectronic apparatus 400 for pattern projection, in accordance with another embodiment of the invention.

Apparatus 400 comprises (similarly to apparatus 100 in FIG. 1) an emitter array 402 comprising emitters 403, refractive optics 404, and an MOE 406, comprising a metasurface 408 formed on a substrate 410. Apparatus 400 further comprises a cover glass 420 above MOE 406, comprising a reflective area 422, and a photodetector 424.

Apparatus 400 produces a high-NA beam pattern, similar to pattern 302 in FIG. 3. The beams generated by emitters 403 are, for the sake of clarity, exemplified by a single beam 412 emitted by an emitter 403a. Optics 404 focus beam 412 into a beam 414, which is further split and collimated to form beams 416a, 416b, 416c, and 416d. A zero-order beam 418 is also shown. Beams 416b and 416c are projected through cover glass 420 toward a target (not shown). Beams 416a and 416d, however, exit MOE 406 at high angles (high NA), similarly to beams 304a-d in FIG. 3.

Beam 416a is at least partially reflected by cover glass 420 back toward apparatus 400. To reduce potentially harmful stray light due to beam 416a, metasurface 408 is designed to reduce the intensity of beam 416a or possibly to extinguish it.

Beam 416d is reflected by reflective area 422 toward photodetector 424, whose signal may be used for monitoring the power of beams 416b, 416c, . . . , emitted from apparatus 400.

FIG. 5 is a schematic side view of an optoelectronic apparatus 500 for pattern projection, in accordance with a further embodiment of the invention. Apparatus 500 is similar to apparatus 400 (FIG. 4), with similar or identical items labelled with the same labels.

Apparatus 500 differs from apparatus 400 in that the intensity of beam 416a is not reduced, and an optical detector array 502, comprising detectors 504, has been added. When beam 416a impinges on a target 506 that is in close proximity to apparatus 500, a reflection 508 of beam 416a returns to detector array 502. By detecting which of detector elements 504 are illuminated by reflection 508, a distance of target 506 from apparatus 500 may be inferred, as described in the above referenced U.S. Patent Application Document 2023/0073962.

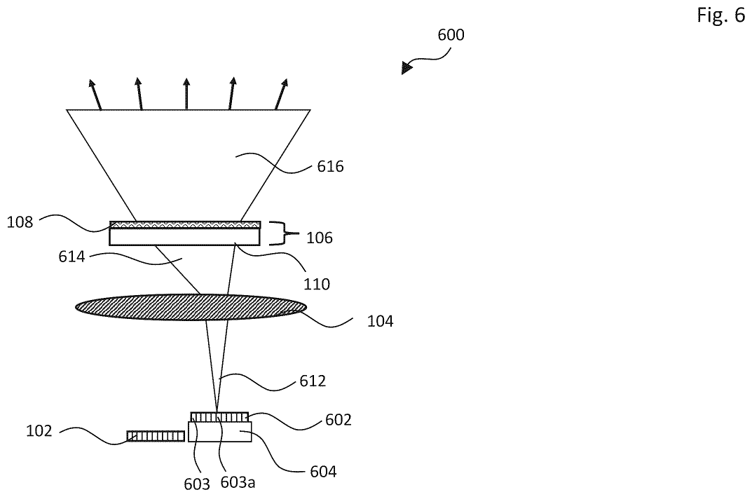

FIG. 6 is a schematic side view of an optoelectronic apparatus pattern and flood projection, in accordance with an embodiment of the invention. Apparatus 600 is similar to apparatus 100 (FIG. 1), with the addition of a second emitter array 602 on a raised platform 604. Similar or identical items to those in apparatus 100 are labelled with the same labels.

Emitter array 602 comprises emitters 603. When emitters 603 are energized, the optical radiation emitted by these emitters illuminates a target with broad and uniform flood illumination. As an example, an emitter 603a in array 602 emits a beam of radiation 612. As platform 604 has raised array 602 toward optics 104, the optics refract beam 612 into a further diverging beam 614. Due to the divergence of beam 614, MOE 106 splits and diffracts it to form broadly diverging and overlapping beams, which together form a uniform and broadly diverging beam 616, illuminating the target with flood illumination. When all emitters 603 of array 602 are energized, they produce further broadly diverging and overlapping beams, thus illuminating the target with flood illumination.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. An optoelectronic apparatus, comprising:
an array of emitters configured to emit beams of optical radiation;
refractive optics configured to focus the emitted beams with a first optical power; and
an optical metasurface configured to split the focused beams to form a pattern of spots and to apply a vergence to the spots with a second optical power so as to project the pattern of spots toward a target.

2. The apparatus according to claim 1, wherein the optical metasurface is further configured to apply a linear spatial phase shift to the pattern of spots so as to deflect a projection angle of the pattern.

3. The apparatus according to claim 2, wherein the first optical power of the refractive optics causes a zero order of the optical metasurface to form a defocused spot on the target, and wherein the defocused spot does not coincide with any of the spots in the pattern due to the deflected projection angle of the pattern.

4. The apparatus according to claim 1, wherein an absolute value of the second optical power is less than the first optical power.

5. The apparatus according to claim 1, wherein the second optical power is positive.

6. The apparatus according to claim 1, wherein the second optical power is negative.

7. The apparatus according to claim 1, wherein the optical metasurface has an additional polynomial phase selected to correct an optical aberration of the refractive optics.

8. The apparatus according to claim 1, wherein the optical metasurface has an additional polynomial phase selected to correct a field curvature of the refractive optics.

9. The apparatus according to claim 1, wherein the first optical power is selected so that a zero order of each of the emitted beams forms a blurred spot on the target.

10. The apparatus according to claim 1, wherein the optical metasurface is disposed on a surface of the refractive optics.

11. The apparatus according to claim 1, wherein the pattern of spots comprises multiple diffraction orders of the emitted beams, and wherein the optical metasurface is configured to control relative intensities of the diffraction orders.

12. The apparatus according to claim 11, wherein the optical metasurface is configured to attenuate one or more of the diffraction orders that are outside a predefined field of view.

13. The apparatus according to claim 11, and comprising an optical detector, which is configured to receive a high diffraction order that is not directed toward the target and to monitor a power of the beams by detecting the high diffraction order.

14. The apparatus according to claim 1, and comprising an optical detector array, which is configured to receive a high diffraction order that is reflected from a part of the target that is in close proximity to the apparatus and to output a signal indicative of a distance of the part of the target from the apparatus.

15. The apparatus according to claim 1, wherein the array of emitters that emits the beams for projecting the pattern of spots is a first emitter array, and wherein the apparatus comprises a second emitter array, which is configured to emit further optical radiation and is disposed alongside the first emitter array and displaced axially relatively to the first emitter array, wherein the refractive optics and optical metasurface are configured to project the further optical radiation onto the target as flood illumination.

16. A method for optical projection, comprising:
focusing beams of optical radiation emitted by an array of emitters using refractive optics with a first optical power; and
applying an optical metasurface to split the focused beams to form a pattern of spots and to apply a vergence to the spots with a second optical power so as to project the pattern of spots toward a target.

17. The method according to claim 16, wherein applying the optical metasurface comprises applying a linear spatial phase shift to the pattern of spots so as to deflect a projection angle of the pattern.

18. The method according to claim 17, wherein the first optical power of the refractive optics causes a zero order of the optical metasurface to form a defocused spot on the target, and wherein the defocused spot does not coincide with any of the spots in the pattern due to the deflected projection angle of the pattern.

19. The method according to claim 16, wherein the optical metasurface has an additional polynomial phase selected to correct at least one of an optical aberration and a field curvature of the refractive optics.

20. The method according to claim 16, wherein the first optical power is selected so that a zero order of each of the emitted beams forms a blurred spot on the target.
